(19) United States
(12) Patent Application Publication
(10) Pub. No.: US 2013/0322121 A1
(43) Pub. Date: Dec. 5, 2013

(54) BACKLIGHT MODULE

(71) Applicant: Wen-Pin Yang, Hsin-Chu (TW)

(72) Inventor: Wen-Pin Yang, Hsin-Chu (TW)

(73) Assignee: Young Lighting Technology Inc., Hsin-Chu (TW)

(21) Appl. No.: 13/902,859

(22) Filed: May 27, 2013

(30) Foreign Application Priority Data
May 29, 2012 (TW) 101210247

(51) Int. Cl. F21V 8/00

(52) U.S. Cl. CPC G02B 6/0085
USPC 362/612

(57) ABSTRACT

A backlight module includes an outer cover, a heat dissipation plate, a frame, a light guide plate, a back plate, and a light source. The outer cover includes a side wall. The heat dissipation plate is disposed within the outer cover and has a flat plate-shaped first end. The frame is disposed within the outer cover. The light guide plate is disposed between the heat dissipation plate and the frame. The back plate is disposed within the outer cover and has a flat plate-shaped second end parallel to the first end of the heat dissipation plate. The light source is disposed on the first end of the heat dissipation plate and has a substrate and a light emitting diode element. The substrate is perpendicular to the first end of the heat dissipation plate. The first end of the heat dissipation plate and the substrate are adjacent to the side wall.

### CROSS-REFERENCE TO RELATED APPLICATION

This application claims the priority benefit of Taiwan application serial no. 101210247, filed on May 29, 2012. The entirety of the above-mentioned patent application is hereby incorporated by reference herein and made a part of this specification.

### BACKGROUND OF THE INVENTION

1. Field of Invention

The invention generally relates to an optical device. More particularly, the invention generally relates to a backlight module.

2. Description of Related Art

Following the advancements in the semiconductor industry and the related electronic industry, the developments of mobile phones, digital cameras, digital video cameras, notebooks, desktop computers, and other digitized tools, etc, move toward the directions of conveniences, multi-functionality and appealing designs. The display screen of these products is an indispensable communicating interface, which allows the user to operate these products more conveniently. Recently, liquid crystal displays (LCDs) have become the mainstream of display screens. However, since the LCDs do not have a light-emitting function themselves, a backlight module is required to provide light beam to the LCD for the display function.

For the liquid crystal televisions, the backlight module commonly employs the back plate, the frame, and the heat sink to fix the light source and the light guide plate and to support the display panel, and uses the outer cover to enfold the afore-mentioned elements. In the conventional design, the back plate and the heat sink are designed to have side wall structures. The side wall structures of the back plate and the heat sink extend in-between the light source and the side wall of the outer cover and thus increase the structural width, leading to the wider frame border of the outer cover shielding the display panel. For this reason, most liquid crystal televisions fail to achieve the requirement of the slim border.

Taiwan Patent No. TWM288395 disclosed a backlight module employing surface mounted technology (SMT) or soldering to fix the light emitting diode (LED) on the metal plate. Taiwan Patent No. TWM426044 disclosed a backlight module having the LED element soldered on the soldering pad of the copper wiring layers. Taiwan Patent No. TWM410894 disclosed a backlight module having the light source(s) attached to the frame border through the insulating thermal adhesive and solder paste.

### SUMMARY OF THE INVENTION

It is therefore an object of the invention to provide a backlight module satisfying the requirement of the slim border.

To achieve these objects and advantages, and in accordance with the purpose of the invention, as embodied and broadly described herein, the invention provide a backlight module including an outer cover, a heat dissipation plate, a frame, a light guide plate, a back plate, and a light source. The outer cover includes a side wall. The heat dissipation plate is disposed within the outer cover and has a flat plate-shaped first end. The frame is disposed within the outer cover. The light guide plate is disposed between the heat dissipation plate and the frame. The back plate is disposed within the outer cover and has a flat plate-shaped second end parallel to the first end of the heat dissipation plate. The light source is disposed on the first end of the heat dissipation plate and has a substrate and a light emitting diode (LED) element. The substrate is perpendicular to the first end of the heat dissipation plate. The first end of the heat dissipation plate is adjacent to the side wall, and the substrate is adjacent to the side wall.

According to the embodiments, the first end of the heat dissipation plate does not extend in-between the light source and the side wall.

According to the embodiments, the frame does not extend in-between the light source and the side wall.

According to the embodiments, the second end of the back plate does not extend in-between the light source and the side wall.

According to the embodiments, the substrate has a back surface, the first end of the heat dissipation plate has a first side edge parallel to the back surface, the frame has a second side edge parallel to the back surface, the back surface, the first side edge, and the second side edge are adjacent to the side wall, and the back surface, the first side edge, and the second side edge are substantially coplanar.

According to the embodiments, the substrate has a front surface opposite to the back surface, and the LED element is disposed on the front surface.

According to the embodiments, the substrate is soldered to the first end of the heat dissipation plate.

According to the embodiments, the outer cover further includes a front block wall connected to one end of the side wall and a back block wall connected to the other opposite end of the side wall, wherein the front block wall, the side wall, and the back block wall form a C-shaped structure, and the C-shaped structure envelops the heat dissipation plate, the frame, the light guide plate, the light source, and the back plate.

According to the embodiments, the outer cover is an integral structure.

According to the embodiments, the first end of the heat dissipation plate is parallel to the back block wall and the second end of the back plate is parallel to the back block wall.

According to the embodiments, the first end of the heat dissipation plate is in contact with the back block wall.

According to the embodiments, the back plate is located between the heat dissipation plate and the back block wall and the backlight module further includes at least one fastening element to fasten the back plate and the back block wall.

According to the embodiments, a display panel and an optical film stack are adapted to be fixed between the front block wall and the frame.

According to the embodiments, the light source is disposed between the frame and the heat dissipation plate.

According to the above descriptions, the light source is disposed on the first end of the heat dissipation plate and is adjacent to and facing the side wall of the outer cover. In other words, the heat dissipation plate and the back plate do not extend in-between the light source and the side wall of the outer cover, such that the gap or distance between the light source and the side wall of the outer cover could be smaller so as to decrease the width of the structure. Thus, when the backlight module is applied to a display apparatus, the width of the outer cover located at the periphery of the display panel could be smaller, which satisfy the requirement of the slim border.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic cross-sectional view of a portion of a backlight module according to one embodiment of this invention.

FIG. 2 is a schematic cross-sectional view of a portion of the backlight module of FIG. 1 assembled with a display panel and an optical film stack.

FIG. 3 is a schematic cross-sectional view of a portion of a backlight module according to another embodiment of this invention.

### DESCRIPTION OF THE PREFERRED EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

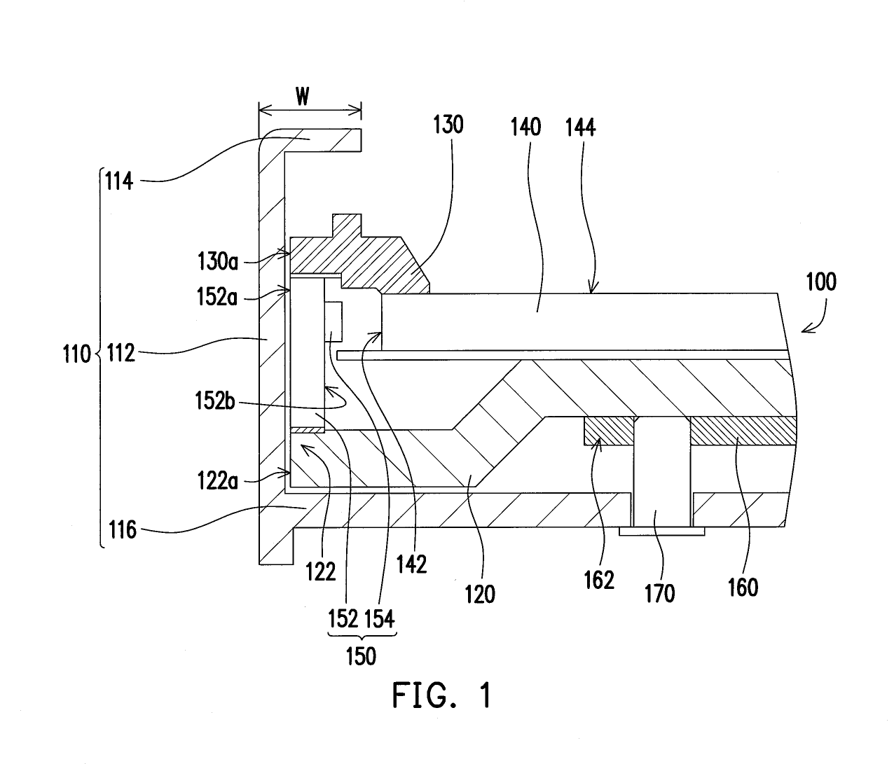

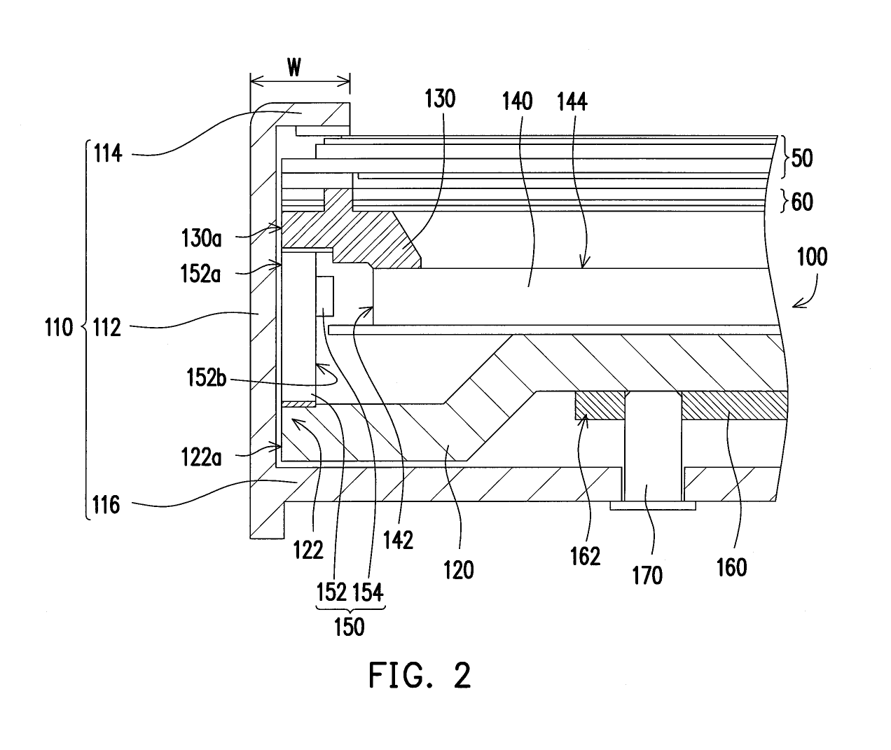

FIG. 1 is a schematic cross-sectional view of a portion of a backlight module according to one embodiment of this invention. As shown in FIG. 1, the backlight module 100 includes an outer cover 110, a heat dissipation plate 120, a frame 130, a light guide plate 140, a light source 150, and a back plate 160 is provided. The outer cover 110 includes a side wall 112, a front block wall 114, and a back block wall 116. The front block wall 114 is a ring frame structure, located at the front end of the side wall 112, while the back block wall 116 covers the back end of the side wall 112. The side wall 112, the front block wall 114, and the back block wall 116 defines a hollow space in-between. The heat dissipation plate 120 is disposed within the outer cover 110 and has a flat plate-shaped first end 122. The frame 130 is disposed within the outer cover 110. The light guide plate 140 is disposed between the heat dissipation plate 120 and the frame 130. The back plate 160 is disposed within the outer cover 110 and has a flat plate-shaped second end 162 parallel to the first end 122 of the heat dissipation plate 120. The light source 150 may be a light emitting diode (LED) light source, for example, including a substrate 152 and an LED element 154. The substrate 152 is disposed on the heat dissipation plate 120 and located at the first end 122 of the heat dissipation plate 120. The substrate 152 may be a printed circuit board (PCB), a metal-core printed circuit board (MCPCB) or other metal plate, for example. The substrate 152 is perpendicular to the first end 122 of the heat dissipation plate 120. As the first end 122 of the heat dissipation plate 120 is adjacent to the side wall 112 of the outer cover 110, the light source 150 is also adjacent to the side wall 112 and the substrate 152 that is disposed on the first end 122 is adjacent to the side wall 112 as well. Herein, the scope of “the substrate 152 being adjacent to the side wall 112” may encompass the substrate 152 being in direct contact with the side wall 112 without any device or elements there-between, a gap existing between the substrate 152 and the side wall 112, or other device or elements, such as flexible circuit boards (like the flexible circuit board of the liquid crystal display panel 50 shown in FIG. 2) etc., existing between the substrate 152 and the side wall 112.

FIG. 2 is a schematic cross-sectional view of a portion of the backlight module of FIG. 1 assembled with a display panel and an optical film stack. Referring to FIG. 2, the liquid crystal display panel 50 and the optical film stack 60 are assembled with the backlight module 100 to form a liquid crystal display (LCD). In details, the liquid crystal display panel 50 and the optical film stack 60 are fixed between the front block wall 114 of the outer cover 110 and the frame 130. The light source 150 of the backlight module 100 is capable of emitting light beam. The light beam enters into the light guide plate 140 from the side surface 142 of the light guide plate 140, exits out of the light emitting surface 144 of the light guide plate 140 and then goes into the liquid crystal display panel 50 and the optical film stack 60, so as to provide the light beam required for the image display of the liquid crystal display panel 50. The liquid crystal display (LCD) may be a liquid crystal television or other apparatus, and will not be limited to the exemplary embodiments.

In the design of the conventional backlight modules, the heat dissipation plate and/or the back plate may include a side wall structure. Since the side wall structure of the heat dissipation plate and the side wall structure of the back plate may extend in-between the light source and the side wall of the outer cover, the light source is not directly adjacent to the side wall of the outer cover and a larger space or gap between the light source and the side wall of the outer cover is required to accommodate the side wall structure of the heat dissipation plate and/or the back plate.

In this embodiment, one end of the heat dissipation plate 120 and one end of the back plate 160 are shaped as flat plates. That is, the first end 122 of the heat dissipation plate 120 is a flat and unbent plate structure, the second end 162 of the back plate 160 is a flat and unbent plate structure, the first end 122 of the heat dissipation plate 120 and the second end 162 of the back plate 160 will not extend in-between the light source 150 and the side wall 112 of the outer cover 120, the light source 150 that is disposed on the first end 122 is adjacent to the side wall 112 of the outer cover 110, such that the gap between the light source 150 and the side wall 112 could be smaller and the width of the structure of the outer cover 110 is decreased. In this embodiment, the first end 122 of the heat dissipation plate 120 is parallel to the back block wall 116, and the second end 162 of the back plate 160 is parallel to the back block wall 116. In this embodiment, the frame 130 may be designed not to extend in-between the light source 150 and the side wall 112, thus further diminishing the gap or distance between the light source 150 and the side wall 112 and decreasing the width of the structure of the outer cover 110. That is, in this embodiment, none of the heat dissipation plate 120, the frame 130, and the back plate 160 extends in-between the light source 150 and the side wall 112. Hence, when the backlight module 100 is assembled with the display panel 50 as shown in FIG. 2, the front block wall 114 that is required to be wide enough to cover the peripheral region of the display panel 50 could have a smaller width W, such that the width of the outer cover 110 located at the periphery of the display panel 50 is smaller, which satisfying the design requirement of the slim border for the display. In other embodiments, the light source may be placed at two opposite sides of the backlight module, while no light source is arranged at the other two opposite sides of the backlight module. Hence, the heat dissipation plate and the back plate at the two opposite sides that are arrange with the light source are flat and unbent plate structures which satisfying the design requirement of the slim border for the display, while the heat dissipation plate and the back plate at the other two opposite sides without the light source have side wall structures for facilitating the fixation of the backlight module. Without the additional width of the light source, the other two opposite sides without the light source may satisfy the requirement of the slim border.

The substrate 152 of the light source 150 may be fixed to the heat dissipation plate 120 by soldering, for example. The substrate 152 of the light source 150 is disposed between the frame 130 and the dissipation plate 120, such that the light source 150 is stably fixed or restrained. In other embodiments, a solder paste may be used to attach the heat dissipation plate 120 and the substrate 152. Alternatively, the substrate 152 and the heat dissipation plate 120 are an integral structure, and the scope of the invention is not limited by the exemplary illustrations.

In this embodiment, the substrate 152 of the light source 150 has a back surface 152a and a front surface 152b opposite to the back surface 152a. The LED element 154 is disposed on the front surface 152b. The first end 122 of the heat dissipation plate 120 has a first side edge 122a parallel to the back surface 152a. The frame 130 has a second side edge 130a parallel to the back surface 152a. The back surface 152a of the substrate 152, the first side edge 122a of the heat dissipation plate 120, and the second side edge 130a of the frame 130 are substantially coplanar and are directly facing and adjacent to the side wall 112 of the outer cover 110. In other embodiments, the back surface 152a, the first side edge 122a, and the second side edge 130a may not be coplanar, and the scope of the invention is not limited by the exemplary illustrations.

In this embodiment, the front block wall 114, the side wall 112, and the back block wall 116 of the outer cover 110 are formed as an integral structure, for example. Particularly, the front block wall 114 is connected to one end of the side wall 112, while the back block wall 116 is connected to the other end of the side wall 112. The front block wall 114, the side wall 112, and the back block wall 116 form a C-shaped structure, which envelops the heat dissipation plate 120, the frame 130, the light guide plate 140, the light source 150, the back plate 160, the display panel 50, and the optical film stack 60. As the outer cover 110 is a C-shaped structure of an integral structure, rather than the assembly of several components, no additional fastening structures or latching structures are required, which is beneficial for diminishing the outer cover size and fulfilling the requirement of the slim border.

The backlight module 100 further includes at least one fastening element 170. The back plate 160 is located between the heat dissipation plate 120 and the back block wall 116 of the outer cover 110. The heat dissipation plate 120 contacts with the back plate 160, so that the heat generated by the light source 150 could be transferred to the back plate 160 through the heat dissipation plate 120. The fastening element 170 is used to fasten the back plate 160 and the back block wall 116 of the outer cover 110. Since the outer cover 110 is fastened to the back plate 160 via the back block wall 116, rather than fastening to the back plate 160 through the side wall 112, the width of the side wall 112 needs not to be increased from the arrangement of the fastening element and the corresponding hole, which is beneficial for achieving the requirement of the slim border.

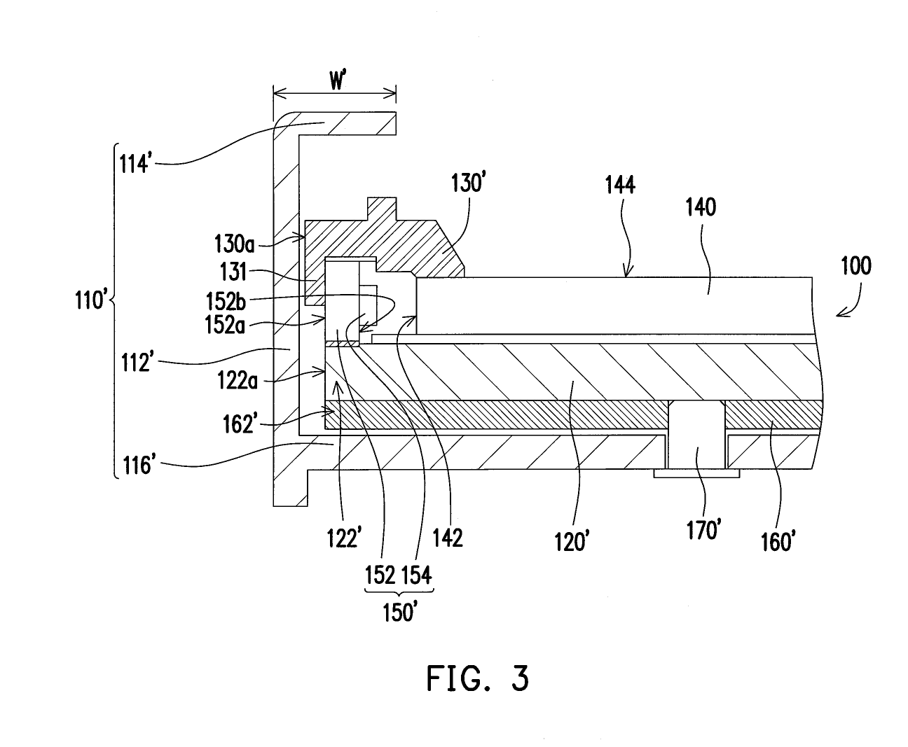

FIG. 3 is a schematic cross-sectional view of a portion of a backlight module according to another embodiment of this invention. Referring to FIG. 3, the backlight module 100a in this embodiment is similar to the backlight module 100 of FIG. 1, and the differences will be detailed in the following descriptions. In this embodiment, the heat dissipation plate 120′ of FIG. 3 does not have the bended structure as shown in the middle of the heat dissipation plate 120 of FIG. 2. The second end 162′ of the back plate 160′ is also parallel to the first end 122′ of the heat dissipation plate 120′, further reducing the total thickness of the backlight module 100a. The first end 122′ of the heat dissipation plate 120′ is a flat and unbent structure, the second end 162′ of the back plate 160′ is also a flat and unbent structure, and the heat dissipation plate 120′ and the back plate 160′ will not extend in-between the light source 150′ and the side wall 112′, such that the structure width could be reduced. In addition, the frame 130′ could be designed to have a side wall 131 extending in-between the light source 150′ and the side wall 112′. In this case, the width W′ of the front block wall 114′ of the outer cover 110′ is increase slightly but still satisfying the requirement of the slim border. The side wall 131 is useful for fixing the backlight module 100a and improves the structural stability of the backlight module 100a. Similar to FIG. 2, the backlight module 100a also includes at least one fastening element 170′. The fastening element 170′ is used to fasten the back plate 160′ and the back block wall 116′ of the outer cover 110′.

In summary, the backlight module and the LCD provided by this invention have at least one of the following advantages. The light source is disposed on the first end of the heat dissipation plate and is adjacent to and facing to the side wall of the outer cover. In other words, the heat dissipation plate and the back plate do not extend in-between the light source and the side wall of the outer cover, such that the gap or distance between the light source and the side wall of the outer cover could be smaller. Thus, when the backlight module is applied to a display apparatus, the width of the outer cover located at the periphery of the display panel could be smaller, which satisfy the requirement of the slim border.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A backlight module, comprising:
an outer cover, having a side wall;
a heat dissipation plate, disposed within the outer cover and having a flat plate-shaped first end;
a frame, disposed within the outer cover;
a light guide plate, disposed between the heat dissipation plate and the frame;
a back plate, disposed within the outer cover and having a flat plate-shaped second end parallel to the first end of the heat dissipation plate; and
a light source, disposed on the first end of the heat dissipation plate and having a substrate and a light emitting diode element, wherein the substrate is perpendicular to the first end of the heat dissipation plate, the first end of the heat dissipation plate is adjacent to the side wall, and the substrate is adjacent to the side wall.

2. The backlight module of claim 1, wherein the first end of the heat dissipation plate does not extend in-between the light source and the side wall.

3. The backlight module of claim 1, wherein the frame does not extend in-between the light source and the side wall.

4. The backlight module of claim 1, wherein the second end of the back plate does not extend in-between the light source and the side wall.

5. The backlight module of claim 1, wherein the substrate has a back surface, the first end of the heat dissipation plate has a first side edge parallel to the back surface, the frame has a second side edge parallel to the back surface, the back surface, the first side edge, and the second side edge are adjacent to the side wall, and the back surface, the first side edge, and the second side edge are substantially coplanar.

6. The backlight module of claim 5, wherein the substrate has a front surface opposite to the back surface, and the light emitting diode element is disposed on the front surface.

7. The backlight module of claim 1, wherein the substrate is soldered to the first end of the heat dissipation plate.

8. The backlight module of claim 1, wherein the outer cover further comprises:
a front block wall, connected to one end of the side wall; and
a back block wall, connected to the other end of the side wall, wherein the front block wall, the side wall, and the back block wall form a C-shaped structure, and the C-shaped structure envelops the heat dissipation plate, the frame, the light guide plate, the light source, and the back plate.

9. The backlight module of claim 8, wherein the outer cover is an integral structure.

10. The backlight module of claim 8, wherein the first end of the heat dissipation plate is parallel to the back block wall and the second end of the back plate is parallel to the back block wall.

11. The backlight module of claim 8, wherein the first end of the heat dissipation plate is in contact with the back block wall.

12. The backlight module of claim 9, wherein the back plate is located between the heat dissipation plate and the back block wall, and the backlight module further comprises at least one fastening element to fasten the back plate and the back block wall.

13. The backlight module of claim 9, wherein a display panel and an optical film stack are adapted to be fixed between the front block wall and the frame.

14. The backlight module of claim 1, wherein the light source is disposed between the frame and the heat dissipation plate.
